(19) United States
(12) Patent Application Publication
(10) Pub. No.: US 2012/0129671 A1
(43) Pub. Date: May 24, 2012

(54) PROFILED HEAT SEALER AND METHODS FOR SHAPED SEALS

(75) Inventor: MARK R. NEASE, Lakeside Park, KY (US)

(73) Assignee: R.A. Jones & Co. Inc., Covington, KY (US)

(21) Appl. No.: 13/303,664

(22) Filed: Nov. 23, 2011

Related U.S. Application Data
(60) Provisional application No. 61/458,513, filed on Nov. 24, 2010.

(51) Int. Cl. B31B 1/64

(52) U.S. Cl. 493/208

(57) ABSTRACT

Web sealing apparatus includes a shaped sealing unit where the shape on one side of the element corresponds to a desired seal pattern in a multiple ply web and a heating element secured to another side of the sealing element, where the heating element is oriented to provide more heat energy to a portion of the sealing element corresponding to a desired seal pattern in one multiple ply portion of said web and less heat energy to a portion of the sealing element corresponding to a desired seal pattern in another portion of said web of fewer plies, The invention includes structure for adjusting the radial position of sealing units on a rotatable drum sealer. Multiple sealing units are adjustably mounted on a sealing drum or wheel for applying varied parameter seals in multiple-ply webs wrapped about said drum in contact with said sealing units. Methods are disclosed.

### RELATED APPLICATION

Benefit is claimed of the filing date of Nov. 24, 2010 of U.S. provisional patent application Ser. No. 61/458,513, which application is incorporated herein by reference as if fully set out and expressed herein.

### FIELD OF THE INVENTION

This invention relates to apparatus and methods for seals in multiple-ply flexible bags and pouches formed on continuous or intermittent motion pouch machines.

### BACKGROUND OF THE INVENTION

In the past, standard sealer technology has been used to accommodate gusset folds. A vertical sealer plate on an adjustable rotary drum has been used to produce a seal in the two-ply vertical seam area defining the pouches, as well as to produce a seal across the four plies of a lower gusset structure of the pouch.

While the typical uniform vertical sealer plates are adjustable on the drum to accommodate different width pouches by adjusting the effective diameter of the drum, the seals provided in the two-ply and in the four-ply area are not optimized for both areas. If enough seal energy is applied to optimize the four-ply gusset seal, the vertical seam seal receives too much energy and can burn through or fail. On the other hand, if the heat energy is optimized for the-two-ply vertical seam, there may not be enough energy provided for sealing the four plies of the gusset seal at the pouch bottom. One of these seals is thus adversely affected with respectively too little or too much heat. One prior method for handling the gusset K-shape seal has been placing a separate gusset heater between vertical sealer bars, but that method does not allow easy diameter adjustment. Even though vertical sealer bar adjustment is known, the adjustment of the gusset sealer is not.

Intermittent motion machines do employ specifically shaped sealer bars, but shaped seals are not believed heretofore available on rotary drum sealers, nor on an adjustable rotary drum sealer for handling a variation of pouch shapes and sizes, particularly in continuous motion apparatus, where both two-ply and four-ply seals, for example, must be produced. And since these respective seals must be applied concurrently as the pouch plies continuously move about the sealer drum, the duration of actual seal energy application is the same and cannot be varied between the respective seals of a pouch.

### SUMMARY OF THE INVENTION

This invention is useful in providing such seals and is particularly useful in a continuous motion rotary sealing drum for forming bags or pouches. This sealing apparatus allows maintenance of the adjustment benefits of diameter adjustable pouching apparatus such as that in U.S. patent application Ser. No. 11/668,205, published on Aug. 9, 2007 under Publication No. 2007/0180794A1. That application is expressly incorporated herein by reference as if fully expressed and set forth herein. The invention can be used in such a pouching operation or in any pouch or bag forming operation where shaped or profiled seals are desirable, such as gusset seals in bags.

The invention can be used in such a pouching operation or in any pouch or bag forming operation where shaped or profiled seals are desirable, such as gusset seals in bags. More particularly, the invention is useful in producing gusset seals where the sealing energy must accommodate both four layer and two layer pouch or bag sections; as well as in producing a variety of seal shapes, whether two layer or otherwise.

A gusset portion of a pouch is defined by a shaped or profiled seal portion typically across four plies of pouch or bag material that is extended from the standard side seal for two plies of pouch material, for example. In one embodiment of the invention, the apparatus contemplates variation of the heat density across the different sealing faces, delivering higher or lower sealing energy to different parts of the seal. For example, the 4 layers of web at a gusset fold may require more heat sealing energy than the 2 layers of the standard, adjacent side seal. However, both seals must be optimally applied at the same time on a rotary sealing drum in a continuous pouching operation. According to the invention, different sealing faces are bolted to a flat heater plate, allowing a single heater apparatus to be used to make slightly different seal sizes or seal shapes.

This invention is useful for any gusset seal where more heat is preferred in the lower (4 layer) gusset part of a standard two-ply side seal in a pouch train, and also useful when a sealing drum diameter supporting the pouch material must be adjusted to provide for pouch width flexibility.

### BRIEF DESCRIPTION OF THE DRAWINGS

For further disclosure, attention is drawn to the following Figures.

FIG. 1 is an isometric illustration of a sealer drum for creating seals, defining bag seals or structure in the bagging materials or discrete pouches, in a multiple-ply pouch web entrained around the sealer drum wherein individual sealer plates are disposed about the drum and are adjustable in radial dimension with respect to the central (horizontal in this case) rotational axis of the drum;

FIG. 2 is a drawing of a portion of the sealing drum of FIG. 1 with three radially adjustable sealing plates shown;

FIG. 3 is a disassembled isometric view of the shaped sealer apparatus according to the invention showing the shaped sealing plate (brown), the heating plate (blue), the mounting elements (black, gray, purple) and components of the rotatable sealing drum below;

FIG. 4 is an isometric view of a shaped sealing plate according to the invention illustrating a wider seal surface at the bottom tapering into an elongated, narrower seal surface extending therefrom. In this embodiment, the wide sealing surface corresponds to a multiple-ply gusset seal while the narrower, elongated sealing surface extending therefrom corresponds to a desired side or vertical seal of fewer plies;

FIG. 5 is an isometric view of a heating plate having a printed heating circuit or elements thereon shown diagrammatically and extending along the plate, roughly in a concentration corresponding to the shape of the sealing surfaces of the sealing plate of FIG. 4. The heating elements of the heating plate are disposed across a wider area at the right hand end of the heating plate, and across a relatively narrower area of the heating plate extending to the left hand end thereof; and

FIG. 6 is an isometric view taken from a perspective interiorly of the sealer drum and showing the rear of the radially adjustable sealing elements mounted on the drum from that perspective.

### DETAILED DESCRIPTION OF THE INVENTION

It will be appreciated that the invention in one embodiment, is useful in producing, for example, gusseted pouches or bags (not shown) having side seals between two pouch layers and bottom seals extending through four pouch layers at the gusseted pouch bottoms.

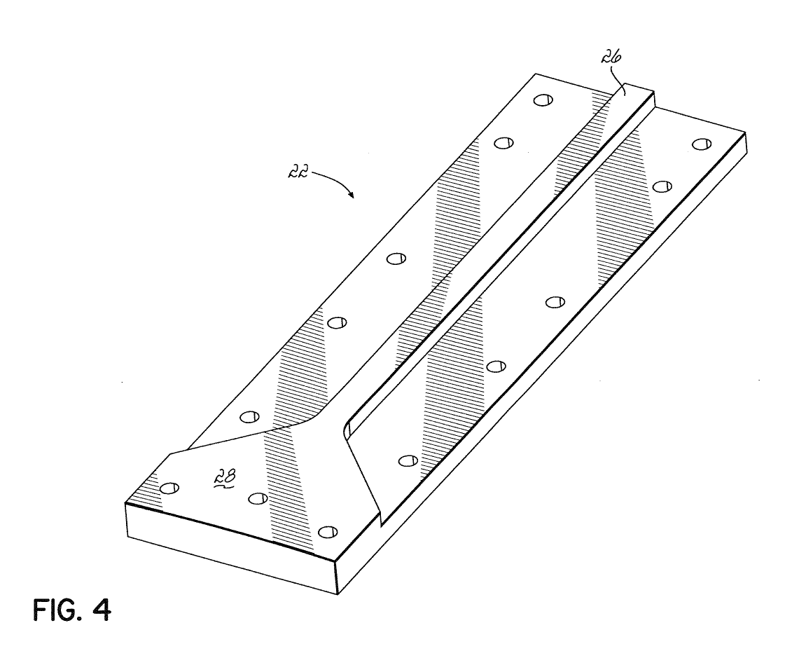

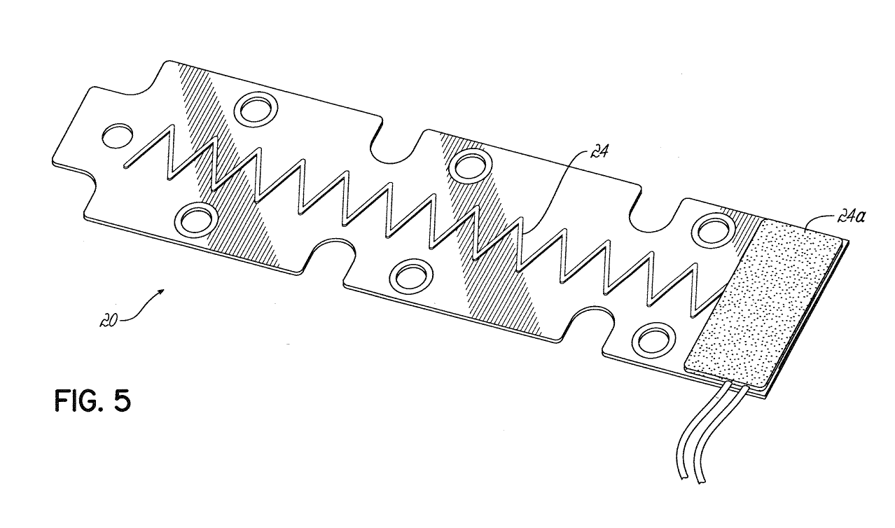

A flat heating element or plate 20 (FIG. 5) provides heat to a profiled sealing surface plate 22 (FIG. 4). The sealing surface plate contacts the pouch or bag web material (not shown) and delivers heat to make the seal. Preferably, there is a slight curve across the face of the sealing surface plate, which roughly is generated with the radius like that of the overall sealing drum. When radial adjustments are made, the mismatch in diameters between the drum and sealing surface plate is minor and does not impact performance.

The heating element 24 of plate 20 uses the same “printed circuit” technology as a standard sealer bar apparatus. In this case the circuit is printed on a flat sheet or plate 20 directly bolted to the sealing surface plate 22, and is essentially corresponding in shape and extent to the shape of the profiled sealer plate 22.

Preferably that plate 22 is in a shape having a vertical section 26 corresponding to the desired vertical seal in two plies of pouch material and is enlarged with lower section 28 corresponding generally in the shape to the gusset seal to be produced across four plies of the pouch material. In a prior standard heater the heat flows from the sides, but in this invention the heat flows into and from the back side of the sealer plate 22 from plate 20. The shape of the “printed circuits” 24 on the heater plate is preferably similar in shape to the shape of both vertical seal and gusset seal on the sealer plate. The shape of the heater circuit 24 thus roughly matches or corresponds to the machined shape of the sealing surface plate portions 26, 28.

The printed circuit heating element 24 can be made in the same shape or in the same outline, as the sealing surface plate 22, so heat is only generated where needed and the heat transfer is consistent.

Likewise, the sealing surface 22 can be made to accommodate any size or shape seal. One particular application is to provide both vertical and gusset seals in two and four-ply areas, but this same technology can be used to make any shaped seal. If the lower seals must extend all the way across the pouch body from one side seal to the other, a traditional bottom sealer can be used in combination to achieve the desired result.

It will be appreciated that the heating plates 20 are mounted directly against the shaped sealing plates 22 and that the more concentrated printed heating circuits 24 are concentrated behind the sealing surfaces 28 of greater area at the lower end of the sealing plates 22 than other sealing surfaces 26 of the sealing plates 22. Thus, the printed circuit 24 is preferably printed on a flat heating plate 20 sandwiched to the shaped sealing plate 22. Since the printed circuit 24 is shaped to generally correspond to the shape of the sealing surfaces 26, 28 of the sealing plate 22, heat is concentrated where required and heat transfer is consistent with the shape of the desired seal. More heat energy is thus applied to the lower gusset seal area of a pouch, for example, than to the upper vertical seal area thereof, thus optimizing the seals produced in each area during the same sealing duration.

As described herein, the printed heating element 24 corresponds in shape and size to the shaped sealing surface 26, 28 of the sealing plate 22. The term “corresponds” as used herein refers to a correlation of the shape, size and extent of the printed heating circuit to the shape, size and extent of the sealing surface but does not require that the relative shape, size and extent of each is exact. Thus, the sealing surfaces 26, 28 may be in the form of a shape as shown, while the printed heating elements 24 may be elongated with runs generally in the confines of the sealing shapes. Direct or coextensive correlation is not required by the term “corresponds”, referring to the functional or operational aspects thereof. Moreover, the heating elements 24 may be more dense in the lower gusset area to produce more sealing heat energy there. Thus, during the same sealing duration period, a two-ply and a four-ply seal is optimized.

While the embodiment of the invention shown is particularly useful in producing both vertical and gusset seals in any suitable pouch or bag in a continuous motion rotary drum sealer, the invention can be used to produce a wide variety of seal shapes. It is further particularly useful in a pouching or bag forming operation where the apparatus is capable of producing various pouch or bag shapes or sizes and contemplates a variation in the diameter or operative circumference of the sealing drum.

Also, it will be appreciated the sealing apparatus, including the sealing and heating plate units, are easily removable for changeover when different seals are desired, as well as radially adjustable for varying pouch widths within a predetermined range.

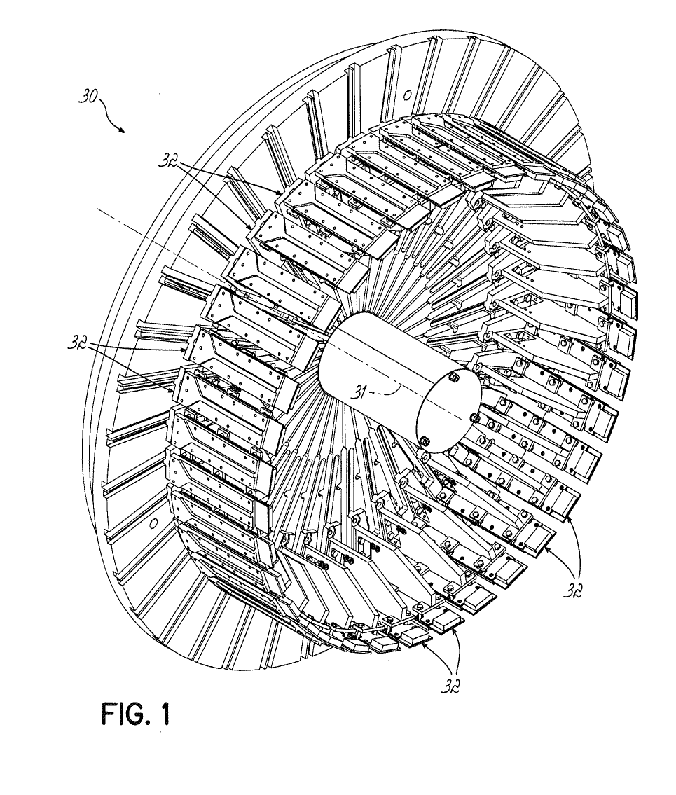

With reference to FIG. 1, a vertical sealer drum or wheel 30 is disposed for rotation about a horizontal axis 31, however, the invention is useful with a horizontal drum or wheel on a vertical axis or with a sealer drum or wheel on any suitable axis at any suitable inclination.

Wheel 30 includes a plurality of sealer units 32 mounted at adjustable radial positions thereon, sealer units 32 including a heater plate 20 and sealing plate 22.

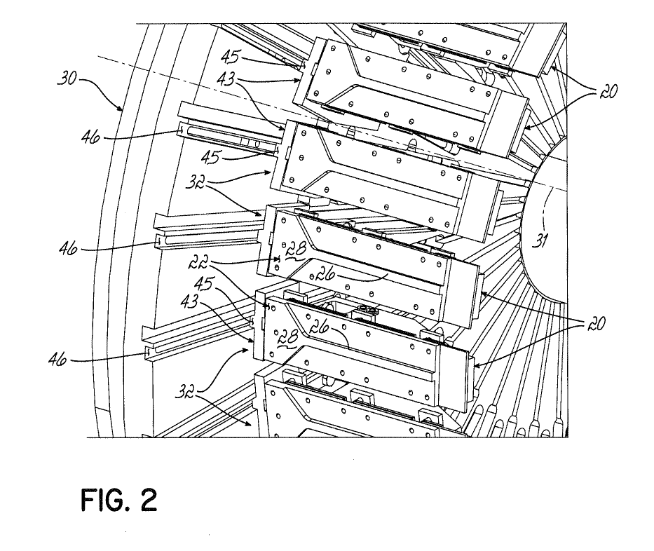

Further details of wheel 30 are shown in FIGS, 2-3 and 6. In FIG. 2, the sealer units 32 face outwardly, generally proximate the operative circumferential extent of wheel 30 so that multiple-ply pouch material can be wrapped therearound for continuous sealing thereof in respective locations. In FIG. 2, sealing units 32 are shown mounted on wheel 30 for respective radial adjustment along radii of the wheel 30. For example, units 32 may be extended in a radially outward direction for larger pouches at increased pitch while units 32 can be retracted radially inwardly, (Shown partially retracted) to accommodate smaller pouches at a reduced pitch where the side seams are closer together.

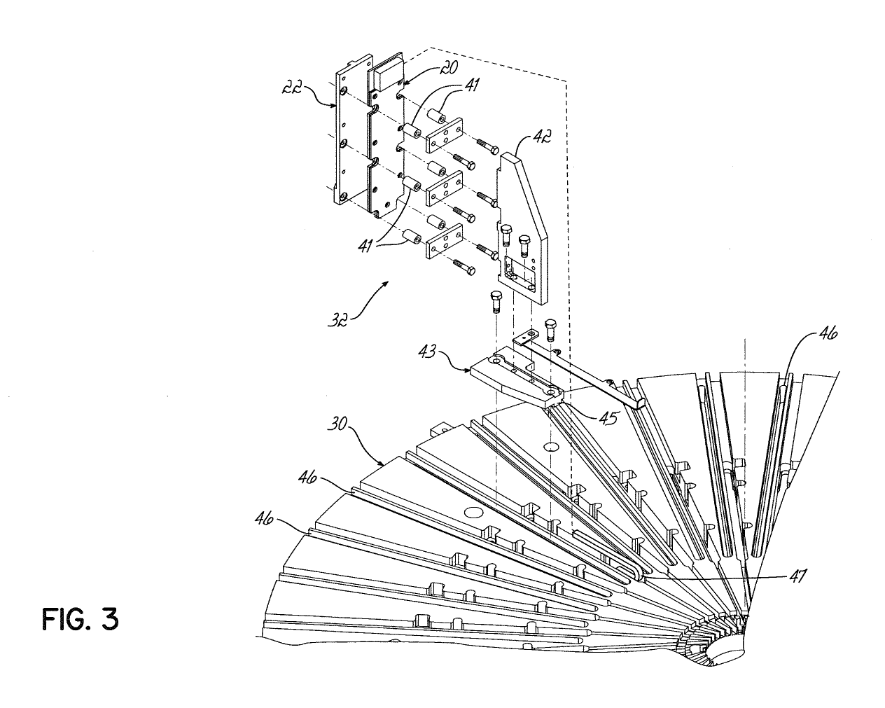

To these ends, as illustrated in FIG. 3, the sealer plate 22 and heater plate 20 are mounted together and preferably to wheel 30 by any suitable bracket structure such as insulators 41, brackets 42, slider 43. A flexible electric conduit 47 is operably attached to the heater elements of plate 20.

Slider 43 is configured to cooperate with a radial slot 46 in wheel 30, via elongated radially-extending projection 45 slidable therein for radial adjustment of units 32. The slider 43, bracket 40 and units 32 are mounted for radial adjustment through slots 46.

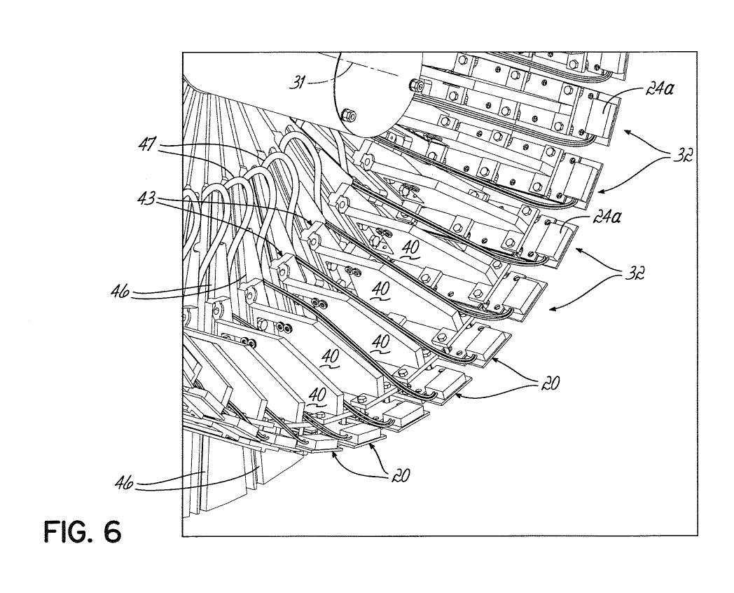

FIG. 6 is a view from inside a wheel 30 showing the slots 46.

While the invention has been described in a preferred embodiment as useful for producing seals in a pouch material of varied plies, the invention also has utility in applying shaped seals between a uniform number of plies. In such a case, the printed circuit would be modified to produce a more uniform heat signature across the entire sealing surface of the sealing plate.

Moreover, the shaped or profiled sealing plate may also be useful in fixed diameter sealers as well as in the adjustable rotary sealer drums as described herein, wherein the sealing apparatus performs the prior function of providing varied shape seals between plies of a pouch or bagging material in a forming process.

These and other modifications and variations of the invention will be readily appreciated by the foregoing to those of ordinary skill in the art without departing from the scope of the invention and applicant intends to be bound only by the claims appended hereto.

What is claimed is:

1. A rotary drum sealer for providing shaped seals in varied multiple plies of materials and including:
a shaped sealer comprising a sealing plate having a shaped sealing surface and a heating plate having a heating element in a shape corresponding to the shaped sealing surface;
said two plates mounted in engagement with each other with the shaped heating element disposed in operative correlation with the shaped sealing surface;
said sealing and heating plates being radially adjustable on said drum; and
said sealing plate and heating plate defining at least two sealing areas of varying heat sealing energy.

2. Apparatus as in claim 1 further including a plurality of sets of said two plates mounted on a rotary drum, each of said sets being radially adjustable on said drum.

3. A method of producing a shaped seal in a work piece comprising the step of engaging a work piece with a shaped seal surface having a heating plate in contact with an opposite side thereof and a printed heating element thereon corresponding to said shaped seal surface, wherein said shaped seal surface and said heating plate define said areas producing different heat sealing energy; and
wherein said plates are radially adjustable together on a rotary sealing drum, the method further comprising producing seals between varied numbers of plies of a pouch or bag material.

4. A method as in claim 3 including the step of producing said seals in said varied number of plies during the same heat sealing duration.

5. A rotary drum sealer for providing shaped seals between plies of materials and including:
a shaped sealer comprising a sealing plate, having a shaped sealing surface, and a heating plate having a heating element in a shape corresponding to the shaped sealing surface;
said two plates mounted together in engagement with each other with the shaped heating element disposed in operative correlation with the shaped sealing surface;
said sealing and heating plates being mounted together with another sealing and heating plate on a rotary carrier;
said sealing plate and heating plate defining at least two sealing areas of varied shape between said plies.

6. Apparatus as in claim 5 wherein each of said heating and sealing plates mounted together comprise a set of sealing units and wherein each of said sets are radially adjustable on said drum.

7. A method of producing a shaped seal in a work piece comprising the step of engaging a work piece with a shaped seal surface having a heating plate in contact with an opposite side thereof and a printed heating element thereon corresponding to said shaped seal surface, wherein said shaped seal surface and said heating plate define sealing areas of different heat shape; and
wherein said plates are mounted on a rotary carrier, the method further comprising producing seals between plies of a pouch or bag material in a plurality of different shapes.

8. A method as in claim 7 including the step of producing said seals in said varied number of plies during the same heat sealing duration.

9. A method for sealing a pouch having opposed side walls and a gusseted multiple ply bottom with side seam seals through said side walls and bottom seals through said multiple ply bottom, said method comprising the steps of:
forming a multiple ply pouch web;
engaging said web with a sealing plate;
sealing portions of said side walls together by applying heat to said side walls; and
sealing portions of said gusted multiple ply bottom together by applying more heat to said gusted bottom.

10. A method as in claim 9 wherein sealing steps have simultaneous duration.

11. A method as in claim 9 wherein said heat applying steps include applying heat through profiled heated surfaces corresponding to shapes of said portions to be sealed.
